(19) United States
(12) Patent Application Publication
(10) Pub. No.: US 2012/0086925 A1
(43) Pub. Date: Apr. 12, 2012

(54) METHOD FOR AVOIDING CONTAMINATION AND EUV-LITHOGRAPHY-SYSTEM

(75) Inventors: Dieter KRAUS, Oberkochen (DE); Dirk Heinrich EHM, Munich (DE); Stefan-Wolfgang SCHMIDT, Aalen (DE); Stefan WIESNER, Lauchheim (DE); Almut CZAP, Aalen (DE); Stefan KOEHLER, Rainau (DE); Hin Yiu Anthony CHUNG, Elchingen (DE)

(73) Assignee: CARL ZEISS SMT GMBH, Oberkochen (DE)

(21) Appl. No.: 13/267,663

(22) Filed: Oct. 6, 2011

Related U.S. Application Data
(63) Continuation of application No. PCT/US2010/001908, filed on Mar. 26, 2010.
(60) Provisional application No. 61/166,975, filed on Apr. 6, 2009.

(30) Foreign Application Priority Data
Apr. 6, 2009 (DE) 10 2009 016 319.0

(51) Int. Cl. G03B 27/52

(52) U.S. Cl. 355/30

(57) ABSTRACT

A method for preventing contaminating gaseous substances (18) from passing through an opening (17b) in a housing (4a) of an EUV lithography apparatus (1), wherein at least one optical element for guiding EUV radiation (6) is arranged in the housing (4a). The method involves: generating at least one gas flow (21a, 21b) which deflects the contaminating substances (18, 18′), and in particular is directed counter to the flow direction (Z) thereof, in the region of the opening (17b). The gas flow (21a, 21b) and the EUV radiation (6) are generated in pulsed fashion and the pulse rate of the gas flow (21a, 21b) is defined in a manner dependent on the pulse rate of the contaminating substances (18, 18′) released under the action of the pulsed EUV radiation (6), wherein both pulse rates are preferably equal in magnitude, and wherein, in the region of the opening (17b), the gas pulses temporally overlap the pulses of the contaminating substances (18, 18′). An associated EUV lithography apparatus at which the method can be carried out is also disclosed.

### REFERENCE TO RELATED APPLICATIONS

This is a Continuation of International Application PCT/2010/001908, with an international filing date of Mar. 26, 2010, which was published under PCT Article 21(2) in German, and the complete disclosure of which, including amendments, is incorporated into the present application by reference. The present application claims the priority of Apr. 6, 2009, of U.S. Provisional Application No. 61/166,975 and also claims the priority of German patent application DE 10 2009 016 319.0 to Apr. 6, 2009. The entire contents of both priority applications are likewise incorporated by reference in their entireties into this present application.

### BACKGROUND OF THE INVENTION

The invention relates to a method for preventing contaminating gaseous substances from passing through an opening of a housing of an EUV lithography apparatus, wherein at least one optical element for guiding EUV radiation is arranged in the housing. The invention also relates to an EUV lithography apparatus for carrying out the method.

In the vacuum system of EUV lithography apparatuses, the optical systems, in particular beam shaping optical unit, illumination optical unit and projection optical unit, are in each case encapsulated in a housing in order that contaminating substances which can form outside the housings e.g. under the action of EUV radiation in exposure operation are kept away from the optical surfaces. At the transitions between the housings, openings for passage of the EUV radiation are provided, at which contaminating substances can enter into the housings, unless suitable countermeasures are implemented.

US 2006/0001958 A1 describes an EUV lithography apparatus wherein a first housing is provided, in which a projection optical unit for imaging a structure on a mask onto a light-sensitive substrate is accommodated, and also a second housing, in which the mask or the light-sensitive substrate is provided. There is a pressure difference between the first and the second housing, wherein the pressure in the first housing is at least a hundred times greater than the pressure in the second housing. By means of the pressure difference, the intention is to bring about a constant gas flow from the first housing into the second housing, in order in this way to avoid the ingress of contaminating substances in the opposite direction. In order to maintain the gas flow or gas curtain, however, a considerable amount of gas is required, which gas can be circulated only by means of pumps having high pumping capacity.

U.S. Pat. No. 6,198,792 has disclosed an EUV lithography apparatus wherein a chamber with a wafer is separated from a projection optical unit arranged in a housing by means of an opening. Situated in the chamber with the wafer there is a device for generating an inert gas flow or inert gas curtain over the surface of the wafer, in order to remove contaminating substances that are released from the wafer during EUV irradiation, by means of the contaminating substances being entrained by the inert gas flow. In this way, the intention is to be able to dispense with the provision of membrane filters at the opening.

US 2006/0268246 A1 has disclosed a lithography apparatus having a gas-purged opening extending between two different regions of the apparatus. A gas supply device supplies the opening with one or more gases selected from a group comprising hydrogen and argon, inter alia. The opening can be configured, in particular, as a tubular passage and a supplied gas flow can be directed counter to contaminating substances which outgas from a wafer.

EP 1 349 010 A1 describes a lithography apparatus wherein a controllable (rotatable) aperture for providing an opening through a barrier between two parts of the apparatus is provided in order to enable a radiation pulse to pass through from the first part of the apparatus into the second part of the apparatus. The controlled aperture closes the opening between the radiation pulses in order to minimize the gas flow between the two parts, and is synchronized with the radiation pulses in order that the latter can pass through the opening of the barrier. In some embodiments, an additional inlet is provided, through which a buffer gas can flow into an interspace between the parts of the apparatus.

### OBJECT OF THE INVENTION

An object of the invention is to improve a method and an EUV lithography apparatus of the type mentioned in the introduction such that the passage of contaminations through the opening of a housing can be prevented in a process-reliable manner and with little outlay.

### SUMMARY OF THE INVENTION

According to one formulation, this object is achieved by a method of the type mentioned in the introduction, comprising: generating at least one gas flow which deflects the contaminating substances, and in particular is directed counter to the flow direction thereof, in the region of the opening, wherein the gas flow and the EUV radiation are generated in pulsed fashion and the pulse rate of the gas flow is defined in a manner dependent on the pulse rate of the contaminating substances released under the action of the EUV radiation, wherein both pulse rates are in particular equal in magnitude, and wherein, in the region of the opening, the gas pulses temporally overlap the pulses of the contaminating substances.

In EUV lithography apparatuses, the EUV radiation is typically generated in pulsed fashion since the high power densities required there cannot be maintained in continuous operation. The inventors have recognized that the release of contaminating substances into the gas phase for example from the photoresist of the wafer takes place under the action of the EUV radiation and thus in pulsed fashion, such that it is not necessary to permanently maintain the gas flow. Rather, the gas flow can likewise be generated in pulsed fashion. The quantity of gas required for this purpose is significantly lower than in the case of a continuously maintained gas flow. Accordingly, the pumping capacity of the pumps that remove the gas flow from the vacuum environment can be significantly reduced, which leads to a considerable reduction of costs.

In this case, the gas pulses can be generated in a delayed fashion with respect to the EUV pulses, wherein the delay time is chosen or set such that, in the region of the opening, the gas pulses temporally overlap the pulses of the contaminating substances. Since the contaminating substances need a certain time to move from the originating location of the contaminations—e.g. the photoresist or the EUV light source—into the region of the opening or to undergo transition to the gas phase under the influence of the EUV radiation, it is necessary to delay the gas pulses with respect to the EUV pulses such that a respective gas pulse in the region of the opening impinges on a respective pressure pulse of the contaminating substances in order to deflect said pressure pulse. In this case, the delay time can be varied, if appropriate, in a manner dependent on parameters of the EUV lithography apparatus which influence the duration of the time of flight of the contaminating substances as far as the opening. By way of example, the delay time can be set e.g. in a manner dependent on the materials used for the coating of the wafer. The dependence of the delay time on the parameters that influence the time of flight can be stored in tables, wherein said dependence was determined experimentally, for example. However, it is also possible to perform regulation of the delay time, e.g. by providing a contamination sensor (e.g. a pressure sensor) outside the housing in the vicinity of the opening. The pulsed gas flow is then activated as soon as the sensor detects the presence of the contaminating substances, e.g. when a threshold value of the measured pressure is exceeded.

In one variant, a pulse duration of the gas pulses is less than 5%, preferably less than 1%, in particular less than 0.5%, of the time interval between two successive pulses of the EUV radiation. As a result, the amount of gas required for deflecting the contaminating substances can be significantly reduced by comparison with a continuous gas flow. In particular, the pulse duration of the gas pulses can also be less than 5 times, preferably less than 3 times, more particularly less than twice, the time duration of the EUV pulses, since the time duration of the contamination pulses is of the order of magnitude of the time duration of the EUV pulses. The amount of gas which is released during an individual gas pulse can in this case be approximately a factor of five to ten greater than the total amount of contaminating substances generated by an EUV pulse.

In a further variant, the momentum of the gas particles contained in the gas flow is chosen to be greater than the momentum of the gaseous contaminating substances. If, in the EUV lithography apparatus, there prevail partial pressures of less than 10⁻⁶ mbar of the contaminating substances, on the one hand, and sufficiently high partial pressures of the gas flow, on the other hand, at which the respective gas molecules follow the physical law of laminar flow (Knudsen number, Λ/d<<0.1, Λ=average free path length of the contaminant in the gas flow, d=typical passage cross section or length), then the ingress of contamination molecules, which are typically long-chain molecules, e.g. hydrocarbons, having a high mass, can be effectively prevented by virtue of the generally lighter molecules of the gas flow being generated with high speed and at high pressure. In this way, in the event of a collision (or ideally a large number of collisions) between a gas molecule of the gas flow and a molecule of the contaminating substance, it can be ensured that the latter reverses its flow direction.

In a further variant, the pulsed gas flow is generated in at least one controllable gas valve. In this case, the gas valve can be driven electronically with a high pulse rate (in the range of a few μs), wherein the amount of gas in the gas flow can be set via the pulse duration or the duty ratio between open and closed states of the gas valve. In particular, variable pressure regulation can also be performed, e.g. by setting a control voltage for opening the valve in a suitable manner (in a temporally varying manner). In this case, the gas valve is designed in such a way that it generates a steep pressure pulse upon opening, such that the emerging gas has a high velocity component and hence a high momentum. The pressure difference between the gas reservoir and the pressure in the interior of the EUV lithography apparatus should be as large as possible, in order to generate a steep pressure pulse, that is to say that the gas reservoir connected to the valve should have a pressure of more than 4 bar, typically of 6 to 10 bar or higher. Such a valve can be realized e.g. as a piezo-valve such as is used e.g. for generating metal clusters which are employed e.g. in fundamental research. In this case, a focused laser beam is directed onto a metal lamina and the metal is locally evaporated. The plasma cloud arising as a result of the laser evaporation is then caused to effect clustering by the steep gas pulse of the piezo-valve, since the atomic collision is fostered by the steeply rising gas pulse edge and the formation of clusters of arbitrary size is thus made possible.

It is expedient to arrange the gas valve in the housing in order to keep the contaminating substances away from the housing using the countercurrent principle. However, if appropriate, a pulsed gas flow oriented transversely with respect to the flow direction of the contaminating substances could also be used, which is arranged outside the housing, e.g. as is described in U.S. Pat. No. 6,198,792, which is incorporated by reference in the content of this application. Moreover, if appropriate, gas valves can also be fitted outside the housing and be oriented toward the originating location of the contaminations.

In a further variant, the gas valve or the outlet opening thereof is arranged in a manner oriented toward the opening of the housing and the gas valve is arranged in a manner offset with respect to the opening. The contaminating substances that penetrate into the housing through the opening or an, in particular tubular, passage arranged, if appropriate, in the region of the opening are ideally exposed to a gas flow having a flow direction opposite to the contaminating substances. Since the opening in the housing is arranged in the region of the beam path of the EUV radiation, the gas valve or gas valves generally cannot be arranged directly at the opening, but rather are arranged in a manner offset with respect thereto, wherein the angle of the gas flow or the gas valve with respect to the opening should be chosen to be as small as possible. The geometry of the outlet opening of the gas valve can be chosen such that a desired geometry of the gas flow generated is established. In the case of a round outlet opening, the gas flow is generally conical; in the case of other forms of the outlet opening, e.g. in the case of an elongate rectangular geometry, a correspondingly shaped, flat gas flow is generated.

In particular, it is also possible for a plurality of gas valves to be arranged in a regular arrangement around the opening, in order to obtain metering of the gas flow generated that is as homogeneous as possible and thus a homogeneous pressure distribution into the opening. The number of gas valves is dependent, inter alia, on the size of the opening. A regular or symmetrical arrangement is understood to be an arrangement wherein the number N of gas valves is distributed at an angle of in each case approximately 360°/N along the circumference of the opening and oriented toward the latter. By way of example, it is possible to use four gas valves each arranged at an angle of 90° with respect to one another.

The gas flow contains at least one gas selected from the group comprising: hydrogen (H₂), nitrogen (N₂), deuterium (D₂) and noble gases, in particular helium (He), argon (Ar) and xenon (Xe). These gases are inert gases, wherein the choice of a suitable gas depends, inter alia, on the mass of the contaminating substances. In the case of contaminating substances having large molecular masses, in general use is also made of gases that tend to have larger masses in the gas flow, in order to generate a greater momentum during the collision processes. In particular H₂, N₂, D₂ and He have a low absorption for the EUV radiation, which has a favorable effect on the absorption if these gases are still present in the EUV lithography apparatus when a subsequent EUV pulse is generated.

In one variant, gases contained in the pulsed gas flow are pumped away (virtually completely) before a subsequent pulse of the EUV radiation, in order that absorption of the EUV radiation by the gases contained in the gas flow is prevented as completely as possible.

In a further variant, a static pressure within the housing is chosen to be at least 10 Pa greater than a static pressure outside the opening of the housing. Such a pressure difference suffices to enable a gas flow from the housing through the opening toward the outside, to prevent the ingress of contaminating substances which are not generated by the EUV radiation, even without the generation of the gas pulses. The pressure in the region of the opening, more particularly within a tubular body arranged there, is approximately 3 Pa in the exposure pauses, that is to say between two successive pulses, and can rise to as much as 20 Pa during EUV pulses.

In one variant, for deflecting electrically charged contaminating substances released under the action of the pulsed EUV radiation, an electromagnetic field, more particularly a homogeneous electric field, is generated in pulsed fashion, the pulse rate of which is defined in a manner dependent on the pulse rate of the contaminating substances, wherein both pulse rates are in particular equal in magnitude. The pulses of the electromagnetic field are generally delayed relative to the EUV pulses, wherein the delay time is chosen such that, in the region of the field, the field pulses temporally overlap the pulses of the contaminating substances. For deflection purposes, it is possible to employ electric and/or magnetic fields which are superposed e.g. in sections. A (pulsed) homogeneous electric field is favorable in this case since this can be generated in a particularly simple manner. In this case, the pulsed homogeneous field can be oriented, in particular, transversely with respect to the opening.

A further aspect of the invention is realized in an EUV lithography apparatus, comprising: a light source for generating EUV radiation, at least one housing with at least one optical element for guiding the EUV radiation, wherein the housing has at least one opening through which contaminating substances can pass, at least one gas generating device for generating a pulsed gas flow in the region of the opening, wherein the gas flow deflects the contaminating substances and is in particular directed counter to the flow direction thereof, and a control device for driving the gas generating device with a pulse rate, which is dependent on the pulse rate of the EUV radiation generated in pulsed fashion, wherein both pulse rates are in particular equal in magnitude, and wherein the control device drives the gas generating device in such a way that, in the region of the opening, the gas pulses temporally overlap the pulses of the contaminating substances.

As explained above, the pulsed gas flow can be used to alter the flow direction of the contaminating substances, in order to prevent the latter from entering into the housing or passing through the opening. In order to synchronize the generation of the gas flow with the EUV pulses, the control device can be connected to the EUV light source.

In one embodiment, the control device is designed for driving the gas generating device for delayed generation of the gas pulses relative to the EUV pulses, wherein a, in particular variable, delay time is chosen such that, in the region of the opening, the gas pulses temporally overlap the pulses of the contaminating substances.

A suitable delay time can be set by measuring or calculating the time until the contamination pulse and the gas flow have respectively reached the opening. The value thus determined is used in the control device in order to synchronize the gas flow with the contamination pulses.

In one embodiment, the control device is designed or programmed for driving the gas generating device for generating gas pulses having a pulse duration of less than 5%, preferably of less than 1%, more particularly of less than 0.5%, of a time period between two pulses of the EUV radiation. The time period between two EUV pulses is generally of the order of magnitude of microseconds, e.g. approximately 100 μs, while the individual EUV pulses generally having a pulse duration of approximately 100 ns. The time duration of the contamination pulses is of the same order of magnitude as the duration of the EUV pulses, e.g. 400 to 500 ns. Even given a duration of the gas pulses of only 0.5% of the time duration between the pulses, therefore, the contaminating substances can be virtually completely kept away from the housing.

In one embodiment, the gas generating device has at least one controllable gas valve. Since in general, although it is indeed possible, using the duration of the pulses, to set the amount of gas, it is not possible to set the achievable maximum gas pressure (typically between 3 and 6 bar) at the gas valve, it may be advantageous to use two or more gas valves in order to generate enough gas molecules with a high momentum such as arise directly after the respective gas valve is switched on. In the case where two or more gas valves are used, they can be opened and closed simultaneously, but they can also alternatively be switched with a short time delay, in order that the number of molecules in the gas flows which have a high momentum is distributed better over the duration of the contamination pulse.

In a further embodiment, the gas valve is arranged in the housing. This is the normal case, wherein, as already explained above, the gas valve is typically arranged in a manner oriented toward the opening and offset with respect to the opening outside the beam path of the EUV radiation. In a further embodiment, a plurality of gas valves are arranged in a in particular regular arrangement around the opening, in order to enable the gas flow to be metered as homogeneously as possible.

In one embodiment, the opening is formed at a tubular passage. The passage can be used to concentrate the contaminating substances at the opening within a spatially narrowly delimited region, such that, with the aid of the gas flows, the contaminating substances can be more easily prevented from passing through the opening.

In one development, the tubular passage has a length of more than 2 cm, preferably of more than 5 cm. This is favorable in order that the gas pulse can form a barrier in the tubular passage, as a result of which the contaminating substances can be suppressed or deflected as effectively as possible.

In a further embodiment, the EUV lithography apparatus additionally comprises a generating device for the pulsed generation of an electromagnetic field, in particular a homogeneous electric field, for deflecting electrically charged contaminating substances released under the action of the pulsed EUV radiation, wherein a pulse rate of the field is defined in a manner dependent on a pulse rate of the contaminating substances, and wherein both pulse rates are in particular equal in magnitude. In general, the field is switched on only after a delay time, which takes account of the propagation time of the contaminating substances until reaching the region in which the field is generated.

In one embodiment, the housing contains a projection optical unit for imaging a structure on a mask onto a light-sensitive substrate. The housing of the projection optical unit has a respective opening to the mask and to the substrate for passage of the EUV radiation. Contaminating substances can outgas from the light-sensitive substrate as a result of the EUV radiation, and the same applies to contaminants (“debris”) which are produced, if appropriate, during pulsed operation by the EUV light source itself and which can pass into the region of the mask.

In a further embodiment, the housing has an illumination optical unit for illuminating a structure on a mask. In this case, too, the opening of the housing to the mask or to the module with the EUV light source can be protected against the ingress of contaminations by one or more pulsed gas flows.

The housing with the beam shaping unit, in which the EUV light source is arranged, can also be protected against the ingress of contaminations in the manner described above. Alternatively, it is also possible, in the manner described above, to prevent contaminants generated by the EUV light source (e.g. when a plasma light source is used) from emerging from the housing.

Further features and advantages of the invention will become apparent from the following description of exemplary embodiments of the invention, with reference to the figures of the drawing, which show details essential to the invention, and from the claims. The individual features can each be realized individually by themselves or as a plurality in any desired combination in a variant of the invention.

### DRAWING

The exemplary embodiments are illustrated in the schematic drawing and are explained in the description below. In the figures:

FIG. 1 shows a schematic illustration of an embodiment of an EUV lithography apparatus according to the invention,

FIG. 2 shows a schematic illustration of a detail from FIG. 1 with a housing, in which two gas valves are oriented toward an opening, and

FIGS. 3a-d show schematic illustrations of a pulse sequence of the EUV radiation (a), of a contamination pulse (b), of the control voltage of the gas valves from FIG. 2 (c), and also the pressure pulses generated by the gas valve.

### DETAILED DESCRIPTION

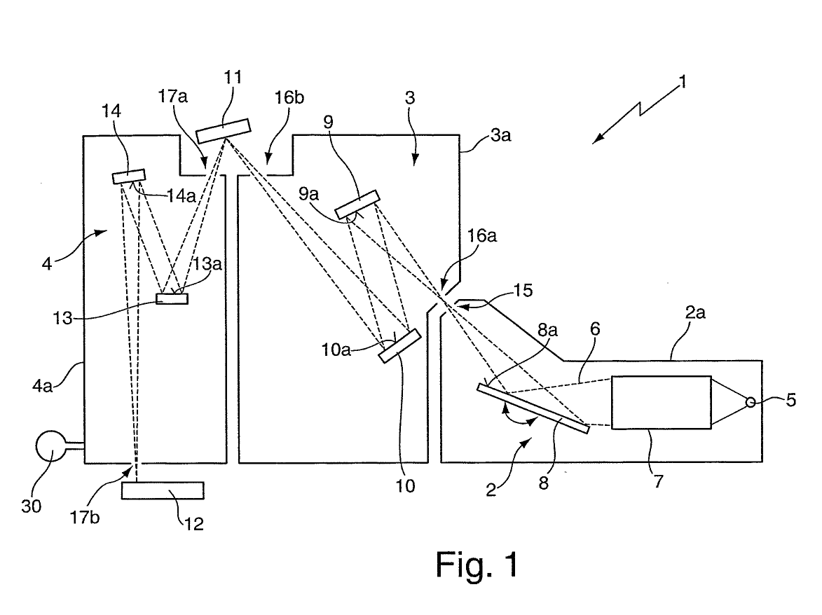

FIG. 1 schematically shows an EUV lithography apparatus 1, having three housings 2a, 3a, 4a, which are embodied as separate vacuum housings and in which a beam shaping system 2, an illumination system 3 and a projection system 4 are arranged, which are arranged successively in a beam path of the EUV radiation 6 that emerges from an EUV light source 5 of the beam shaping system 2. By way of example, a plasma source or a synchrotron can serve as EUV light source 5. The emerging radiation in the wavelength range of between approximately 5 nm and approximately 20 nm is firstly concentrated in a collimator 7. With the aid of a downstream monochromator 8, the desired operating wavelength is filtered out by variation of the angle of incidence, as indicated by a double-headed arrow. In said wavelength range, the collimator 7 and the monochromator 8 are usually embodied as reflective optical elements, wherein at least the monochromator 8, at its optical surface 8a, has no multilayer system, in order to reflect a wavelength range having the widest possible bandwidth.

The radiation treated with regard to wavelength and spatial distribution in the beam shaping system 2 is transferred into the illumination system 3 via an opening 15 on the beam shaping system 2, said illumination system having—by way of example—a first and second reflective optical element 9, 10. The two reflective optical elements 9, 10 are embodied as facet mirrors for pupil shaping and direct the EUV radiation onto a mask 11 as a further reflective optical element, said mask having a structure that is imaged on a demagnified scale onto a wafer 12 by the projection system 4. For this purpose, a third and fourth reflective optical element 13, 14 are provided in the projection system 4. The reflective optical elements 9, 10, 11, 12, 13, 14 respectively have an optical surface 9a, 10a, 11a, 12a, 13a, 14a arranged in the beam path 6 of the EUV lithography apparatus 1. A respective opening 16a, 16b, 17a, 17b for entry/exit for the EUV radiation 6 is formed both at the housing 3a of the illumination system 3 and at the housing 4a of the projection system 4.

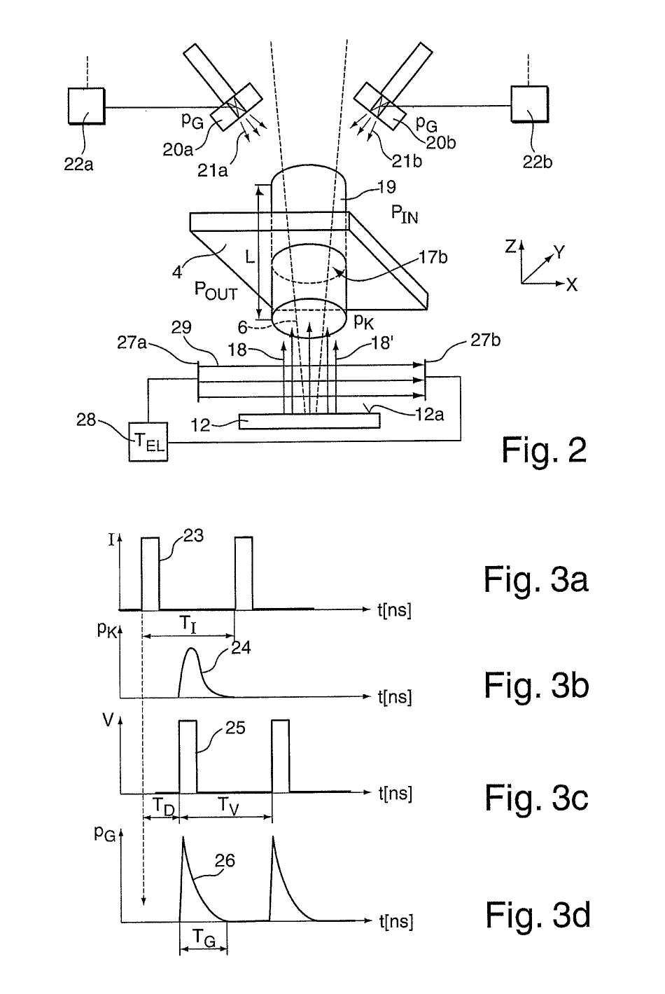

A description is given below by way of example, with reference to FIG. 2, of how the ingress of contaminating substances 18 into the housing 4a can be effectively prevented at the opening 17b for the EUV radiation 6 to exit from the projection system 4. In this case, the opening 17b is formed at a tubular passage 19 of the housing 4a, only an excerpt from which is illustrated in FIG. 2. Two gas valves 20a, 20b, which are fitted in the housing 4a, are arranged in a manner offset with respect to the opening 17b, serve as a gas generating device, are arranged outside the beam path of the EUV radiation 6 at an angle with respect to the plane of the opening 17b and are oriented toward the opening 17b, respectively generate a gas flow 21a, 21b directed at the opening 17b. As is indicated by arrows in FIG. 2, the gas flows 21a, 21b have a large flow component in the negative Z direction, that is to say that they are directed substantially counter to the flow direction (positive Z direction) of the contaminating substances 18. The gas valves 20a, 20b are driven electronically using a respective control device 22a, 22b in order to enable or stop the gas supply to gas reservoirs (not shown). In this case, the gas used for the gas flows 21a, 21b is at a high pressure of typically 6 to 10 bar or higher.

The temporal profile when the contaminating substances 18 arise is illustrated below with reference to FIGS. 3a,b. During exposure operation, the EUV lithography apparatus 1 is operated in pulsed fashion, that is to say that the EUV light source 5 emits short EUV light pulses 23, typically in the range of a few nanoseconds (up to approximately 100 ns), the intensity profile I of which light pulses is illustrated in FIG. 3a. Under the influence of the pulsed EUV radiation 6, the contaminating substances 18 are released from a light-sensitive layer 12a (photoresist) applied on the wafer 12, which contaminating substances can be, depending on the chemical composition of the photoresist 12a, for example organic, i.e. generally long-chain molecules. A pressure profile p_{K}—generated by the pulsed EUV radiation 6—of a pressure pulse 24 of the contaminating substances 18 is shown by way of example in FIG. 3b.

In order to prevent the pressure pulse 24 of the contaminating substances 18 from being able to enter into the interior of the housing 4a through the opening 17b, the gas valves 20a, 20b are driven with a pulsed control voltage V, the temporal profile of which is illustrated in FIG. 3c. In this case, the voltage pulses 25 have a pulse rate 1/Tᵥ equal in magnitude to the pulse rate 1/T_{I} (e.g. of 10 kHz) with which the EUV pulses 23 are generated, wherein this pulse rate corresponds to the rate with which the pulses 24 of the contaminating substances 18 are generated. The voltage pulses 25 are furthermore shifted relative to the EUV pulses 23 by a delay time T_{D} chosen such that the gas pulses 26 of the gas flows 21a, 21b generated in pulsed fashion, the pressure profile p_{G} of which is illustrated in FIG. 3d, are synchronized with the pulses 24 of the contaminating substances 18, that is to say that both overlap temporally to the greatest possible extent at the location of the opening 17b.

Since, in the EUV lithography apparatus 1, the total pressure or the partial pressures of the contaminating substances 18 and of the gas flows 21a, 21b are chosen such that the latter generate a laminar flow through the opening 17b or the tube 19, the contaminating substances 18 can be kept back from the housing 4a by collisions between the respective gas particles. In this case, the mass m_{G} and the velocity v_{G} of the gas molecules of the gas flows 21a, 21b are chosen such that the momentum p_{G}=m_{G} v_{G} thereof is greater than the momentum p_{K} of the contaminating substances 18, which is composed of mass m_{K} and velocity v_{K} (p_{K}=m_{K} v_{K}). In this way, the flow direction of the contaminating substances 18 can be reversed and the latter can thus be effectively prevented from being able to enter into the housing 4a. In this case, although providing a tube 19 at the opening 17b is favorable, it is not mandatory. However, if the tubular passage 19 is used, it should have a length L of typically more than 2 cm, more particularly of more than 5 cm, such that the gas flows 21a, 21b in the tubular passage 19 can form a barrier keeping the contaminating substances 18 away from the housing 4a as effectively as possible.

In this case, the gas type(s) chosen for the gas flows 21a, 21b and also the background pressure for the gas valves 20a, 20b—typically between 6 and 10 bar—should be adapted to the type or mass and velocity of the contaminating substances 18, such that the condition m_{G} v_{G}>m_{K}V_{K} is met as well as possible. By way of example, hydrogen, heavy water, nitrogen or noble gases such as He, Ne, Ar, Kr, Xe can be used as gases in the gas flows 21a, 21b. As can be discerned in FIG. 3d, for the type of gas valve 20a, 20b used, the gas pulses 26 have a greatly rising edge, which results in a high velocity component of the gases used. Therefore, it may be expedient, if appropriate, to provide the gas flows 21a, 21b with a very small time offset in order that a sufficient number of molecules with high velocity oppose the pressure pulse 24 of the contaminating substances 18 during its entire temporal profile.

Typically, a pulse duration T_{G} of the gas pulses 26 is chosen which is less than 5%, preferably less than 1%, more particularly less than 0.5%, of the time interval T₁ between two successive pulses 23 of the EUV radiation. More particularly, the time duration T_{G} of an individual gas pulse 26 can be at most five times, preferably at most three times, more particularly at most twice, the time duration of an individual EUV pulse 23.

Although the gases contained in the pulsed gas flow 21a, 21b are generally chosen such that they have only low absorption for EUV radiation, it is favorable if they are removed from the housing 4a and also from the region in front of the opening 17b of the housing 4a before a subsequent EUV pulse 23 is generated. For this purpose, a pump device 30 (cf. FIG. 1) can be provided in the housing 4a, wherein the pump device 30 is dimensioned and arranged such that it can remove the gases contained in the gas flow 21a, 21b from the housing 4a before a subsequent EUV pulse 23. Corresponding pump devices can also be fitted in the space between the wafer 12 and the opening 17b.

In contrast to the illustration in FIG. 2, one or more gas valves can also open directly into the tubular body 19 in order to generate a pulsed gas flow directed counter to the contaminating substances 18. It is also possible to generate a—in the present case pulsed—transverse gas curtain in the tube 19, e.g. in a manner as is described in US 2006/0268246 A1 cited in the introduction.

In general, a (static) pressure P_{IN} within the housing 4a is chosen to be at least 10 Pa greater than a (static) pressure P_{OUT} outside the opening 17b of the housing 4a in order, even in the time periods in which no gas pulses are generated, to avoid ingress of contaminating substances into the housing 4a or to enable a continuous gas flow from the housing 4a through the opening 17b.

As can likewise be discerned in FIG. 2, a pulsed electric field 29 is generated in the EUV lithography apparatus in the region outside the housing 4a and in front of the opening 17b. In this case, the field 29 is generated by a field generating unit in the form of a voltage source 28, which puts a first and second electrically conductive plate 27a, 27b at different electrostatic potentials (in pulsed fashion), such that the homogeneous electric field 29 shown in FIG. 3 forms between said plates 27a, 27b, said electric field being maintained for a time duration of e.g. from three to four times the time duration of the contamination pulses 24. The electric field 29 serves for deflecting a portion 18′ of the contaminating substances 18 which is electrically charged (ionized), such that this portion is deflected laterally toward the negatively charged plate 27b and can be neutralized there. The contaminating substances 18′ deflected by the field 29 can be extracted by suction by an extraction device (pump) fitted in the region of the negatively charged plate 24b.

As in the case of the gas pulses 26, the electric field 29 is also generated with a pulse rate 1/T_{EL} defined in a manner dependent upon the pulse rate 1/T₁ of the contaminating substances 18 or 18′, wherein both pulse rates are generally chosen to be equal in magnitude. Moreover, the field pulses are generally generated with a delay time relative to the EUV pulses 23 which corresponds to the time duration required by the contaminating substances 18′ from the wafer 12 to the field 29. Since the path of the contaminating substances 18′ from the wafer 12 to the field 29 is smaller than the path to the opening 17b, the delay time of the electric field pulses is typically somewhat shorter than the delay time T_{D} of the gas pulses 26.

The method described above can be used not just in the case of the exit opening 17b of the housing 4a of the projection system 4, but that it can also be effected at the other openings 15, 16a, 16, 17a of the housings 2, 3, 4. In particular, in this case, the projection system 4 or the illumination system 3 can be protected not only against contaminating substances 18 outgassing from the wafer 12, but also contaminating substances which, depending on the used type of EUV light source 5, are generated by the latter, if appropriate. It is likewise possible to prevent contaminating substances from passing through at the opening 15 of the housing 2a of the beam shaping system 2, wherein, in this case, if appropriate, the suppression of contamination can also be effected in the opposite direction, appropriately, that is to say that gas valves are arranged outside the housing 2a in order to prevent contaminating substances generated by the EUV light source 5 from emerging from the beam shaping system 2.

In all cases described above, a pulsed “gas curtain” can be generated by the pulsed metering of gases, in order to achieve effective avoidance of contamination at the optical surfaces 9a to 14a of the optical elements 9 to 14 of the EUV lithography apparatus 1, without a large amount of gas being required for this purpose. Furthermore, the passage 19 shown in FIG. 2 need not necessarily have a circular geometry, but rather may, if appropriate, also have a different, e.g. rectangular, geometry.

More or fewer than two gas valves can also be provided at an opening 15, 16a, 16b, 17a, 17b depending on how great the amount of contaminating substances or the momentum thereof turns out to be and depending on the dimensioning of the opening 15, 16a, 17a, 17b. In general, the gas valves are distributed uniformly along the circumference of the opening 15, 16a, 17a, 17b, in order to ensure homogeneous pressure metering. Such a uniform arrangement can be achieved e.g. if a number N of gas valves are distributed at an angle of in each case approximately 360°/N along the circumference. By way of example, for this purpose it is possible to use four gas valves arranged in each case at an angle of 90° with respect to one another.

1. A method for preventing contaminating gaseous substances from passing through an opening in a housing of an extreme-ultraviolet (EUV) lithography apparatus, wherein at least one optical element for guiding EUV radiation is arranged in the housing, comprising:
generating at least one gas flow which deflects the contaminating substances in a region of the opening, and
generating the EUV radiation, as well as the gas flow, in pulsed fashion, wherein the pulse rate (1/Tᵥ) of the gas flow depends on a pulse rate (1M) of the contaminating substances released under the action of the pulsed EUV radiation, and wherein, in the region of the opening, the gas pulses overlap temporally with the pulses of the contaminating substances.

2. The method as claimed in claim 1, wherein the gas flow is directed counter to a flow direction of the contaminating substances.

3. The method as claimed in claim 1, wherein the pulse rate of the contaminating substances (1/T_{I}) equals the pulse rate of the gas flow 1/T_{V}).

4. The method as claimed in claim 1, wherein the gas pulses are generated in a delayed fashion with respect to the EUV pulses, and wherein the delay time (T_{D}) is for the gas pulses is selected such that, in the region of the opening, the gas pulses temporally overlap the pulses of the contaminating substances.

5. The method as claimed in claim 1, wherein a pulse duration of the gas pulses is less than 5% of a time period (Tᵢ) between two pulses of the EUV radiation.

6. The method as claimed in claim 5, wherein the pulse duration of the gas pulses is less than 0.5% of the time period (Tᵢ) between two pulses of the EUV radiation.

7. The method as claimed in claim 1, wherein a momentum (p_{G}) of gas particles contained in the gas flow is selected to be greater than a momentum (p_{K}) of the gaseous contaminating substances.

8. The method as claimed in claim 1, wherein the pulsed gas flow is generated via at least one controllable gas valve.

9. The method as claimed in claim 8, wherein the gas valve is arranged in the housing.

10. The method as claimed in claim 8, wherein the gas valve is arranged oriented toward the opening and offset with respect to the opening.

11. The method as claimed in claim 8, wherein a plurality of the gas valves are arranged in a regular arrangement around the opening.

12. The method as claimed in claim 1, wherein the gas flow contains at least one gas selected from the group consisting of: hydrogen (H₂), nitrogen (N₂), deuterium (D₂) and noble gases.

13. The method as claimed in claim 1, further comprising pumping away gases contained in the pulsed gas flow before generating a subsequent pulse of the EUV radiation.

14. The method as claimed in claim 1, further comprising selecting a static pressure (P_{IN}) within the housing to be at least 10 Pa greater than a static pressure (P_{OUT}) outside the opening of the housing.

15. The method as claimed in claim 1, further comprising generating an electromagnetic field in pulsed fashion, for deflecting electrically charged contaminating substances released under action of the pulsed EUV radiation, the pulse rate (1/T_{EL}) of the electromagnetic field being defined to depend on a pulse rate (1/T_{I}) of the contaminating substances.

16. The method as claimed in claim 15, wherein the electromagnetic field is an electrostatic field.

17. The method as claimed in claim 15, wherein the pulse rate of the contaminating substances (1/T_{I},) equals the pulse rate of the electromagnetic field 1/T_{EL}).

18. An extreme-ultraviolet-lithography apparatus, comprising:
a light source configured to generate extreme ultraviolet (EUV) radiation at a pulse rate (1/T_{I}), at least one housing with at least one optical element configured to guide the EUV radiation, wherein the housing has at least one opening through which contaminating substances can pass,
at least one gas generating device configured to generate a pulsed gas flow in a region of the opening, which gas flow deflects the contaminating substances and
a control device configured to drive the gas generating device with a pulse rate (1/T_{V}) dependent on the pulse rate (1/T_{I}) of the EUV radiation wherein the control device drives the gas generating device i such that, in the region of the opening, the gas pulses overlap temporally with the pulses of the contaminating substances.

19. The EUV lithography apparatus as claimed in claim 18, wherein the gas flow deflects the contaminating substances in a direction counter to the flow direction (Z) of the contaminating substances,

20. The EUV lithography apparatus as claimed in claim 18, wherein the EUV radiation pulse rate (1/T_{I}) equals the pulse rate (1/T_{V}) of the gas generating device.

21. The EUV lithography apparatus as claimed in claim 18, wherein the control device is configured to drive the gas generating device to delay the generation of the gas pulses relative to the EUV pulses with a delay time (T_{D}) selected such that, in the region of the opening, the gas pulses overlap temporally with the pulses of the contaminating substances.

22. The EUV lithography apparatus as claimed in claim 18, wherein the control device is configured to drive the gas generating device to generate gas pulses having a pulse duration (T_{G}) of less than 5% of a time period (T_{I}) between two pulses of the EUV radiation.

23. The EUV lithography apparatus as claimed in claim 22, wherein the control device is configured to drive the gas generating device to generate gas pulses having a pulse duration (T_{G}) of less than 0.5% of the time period (T_{I}) between two pulses of the EUV radiation

24. The EUV lithography apparatus as claimed in claim 18, wherein the gas generating device comprises at least one controllable gas valve.

25. The EUV lithography apparatus as claimed in claim 24, wherein the gas valve is arranged in the housing.

26. The EUV lithography apparatus as claimed in claim 24, wherein the gas valve is arranged oriented toward the opening and offset with respect to the opening.

27. The EUV lithography apparatus as claimed in claim 24, wherein a plurality of the gas valves are arranged in a regular arrangement around the opening.

28. The EUV lithography apparatus as claimed in claim 18, wherein the opening is formed at a tubular passage.

29. The EUV lithography apparatus as claimed in claim 28, wherein the tubular passage has a length (L) of more than 2 cm.

30. The EUV lithography apparatus as claimed in claim 18, further comprising:
a generating device configured to generate, in pulses, a electromagnetic field, for deflecting electrically charged contaminating substances released under action of the pulsed EUV radiation, wherein a pulse rate (1/T_{EL}) of the field depends on a pulse rate (1/T_{I}) of the contaminating substances.

31. The EUV lithography apparatus as claimed in claim 30, wherein the electromagnetic field is an electrostatic field, and wherein the pulse rate (1/T₁) of the contaminating substances is equal to the pulse rate (1/T_{EL}) of the field.

32. The EUV lithography apparatus as claimed in claim 18, wherein the housing contains a projection system configured to image a structure on a mask onto a light-sensitive substrate.

33. The EUV lithography apparatus as claimed in claim 18, wherein the housing contains an illumination system configured to illuminate a structure on a mask.

34. The EUV lithography apparatus as claimed in claim 18, wherein the housing contains a beam shaping system comprising the light source.
